(19) United States
(12) Patent Application Publication
(10) Pub. No.: US 2012/0161952 A1
(43) Pub. Date: Jun. 28, 2012

(54) BLACK BOX FOR VEHICLE AND ACCESS AUTHORIZATION METHOD THEREOF

(75) Inventors: Hong Bok WE, Gyunggi-do (KR); Won Wook SO, Gyunggi-do (KR); Jong Heum PARK, Gyunggi-do (KR)

(73) Assignee: SAMSUNG ELECTRO-MECHANICS CO., LTD., Gyunggi-do (KR)

(21) Appl. No.: 13/117,762

(22) Filed: May 27, 2011

(30) Foreign Application Priority Data
Dec. 28, 2010 (KR) 10-2010-0136871

(51) Int. Cl. B60Q 1/00

(52) U.S. Cl. 340/436

(57) ABSTRACT

There are provided a black box for a vehicle automatically transmitting an emergency rescue signal at the time of the occurrence of a traffic accident and allowing only authorized persons to access video data at the time of the occurrence of the traffic accident, and an access authorization method thereof. The black box includes: a sensor sensing vehicle impact; a controller performing a control to store video that is being recorded, transmit a rescue signal, permit authorized access to stored video data, when the amount of vehicle impact sensed by the sensor is equal to or greater than a preset reference value; a storing unit storing the recorded video according to the control of the controller; a communicating unit transmitting the rescue signal to a preset object according to the control of the controller; and an authorizing unit authorizing access to the stored video data from the outside.

### CROSS-REFERENCE TO RELATED APPLICATIONS

This application claims the priority of Korean Patent Application No. 10-2010-0136871 filed on Dec. 28, 2010, in the Korean Intellectual Property Office, the disclosure of which is incorporated herein by reference.

### BACKGROUND OF THE INVENTION

1. Field of the Invention

The present invention relates to a black box for a vehicle, and more particularly, to a black box for a vehicle automatically transmitting an emergency rescue signal at the time of the occurrence of a traffic accident and allowing only authorized persons to access video data at the time of the occurrence of the traffic accident, and an access authorization method thereof.

2. Description of the Related Art

Generally, while the number of users using a vehicle has significantly increased, there are not many people capable of appropriately coping with a traffic accident when a traffic accident occurs.

Recently, there is an increasing trend toward mounting a black box storing traffic accident recording data in a vehicle in order to allow the majority of users using vehicles to appropriately cope with traffic accidents.

The black box stores information such as vehicle location, degree of impact applied to the vehicle, or the like, at the time of the occurrence of a traffic accident as well as video recorded via a camera at the time of the occurrence of the traffic accident, to be usefully used for coping with the traffic accident.

However, there are problems in that emergency rescue services should be requested according to an injured person's degree of injury at the time of the traffic accident, in addition to the mounting of the black box, and any person accessing the black box may easily acquire the information stored therein.

### SUMMARY OF THE INVENTION

An aspect of the present invention provides a black box for a vehicle automatically transmitting an emergency rescue signal at the time of the occurrence of a traffic accident and allowing only authorized persons to access video data at the time of the occurrence of a traffic accident, and an access authorization method thereof.

According to an aspect of the present invention, there is provided a black box for a vehicle, the black box including: a sensor sensing vehicle impact; a controller performing a control to store video that is being recorded, transmit a rescue signal, permit authorized access to stored video data, when the amount of vehicle impact sensed by the sensor is equal to or greater than a preset reference value; a storing unit storing the recorded video according to the control of the controller; a communicating unit transmitting the rescue signal to a preset object according to the control of the controller; and an authorizing unit authorizing access to the stored video data from the outside.

The controller may perform a control to store video recorded from a first preset time prior to sensing the vehicle impact to a second preset time after sensing the vehicle impact.

The controller may include a sensor controller receiving the amount of vehicle impact sensed by the sensor and controlling an operation of the sensor; a camera controller receiving the sensed amount of vehicle impact from the sensor controller and controlling an operation of a camera recording video; a communication controller controlling communication with the preset object according to the sensed amount of vehicle impact from the sensor controller; and an authorization controller encrypting the video data stored in the storing unit and permitting access to the encrypted video data when the access is authorized by the authorizing unit.

The authorizing unit may include a near field communication unit receiving a video data access signal from a user within a preset near field communication range; and a code confirming unit confirming whether the video data access signal transmitted through the near field communication unit includes a preset authorization key.

The near field communication unit may communicate in a non-contact near field communication scheme.

The near field communication unit may communicate in a non-contact near field communication scheme using a frequency of 13.56 Hz or a radio frequency identification (RFID) scheme using a frequency of 900 MHz

According to another aspect of the present invention, there is provided an access authorization method of a black box for a vehicle, the access authorization method including: sensing an amount of vehicle impact; storing video that is being recorded and transmitting a rescue signal to a preset object when the sensed amount of vehicle impact is equal to or greater than a preset reference value; and confirming whether access to stored video data is an authorized access.

The storing of the video that is being recorded may include storing video recorded from a first preset time prior to sensing the vehicle impact to a second preset time after sensing the vehicle impact.

The confirming of the authorized access may include encrypting the stored video data and permitting access to the encrypted video data when the access is authorized.

The confirming of the authorized access may include receiving a video data access signal from a user within a preset near field communication range, and confirming whether the video data access signal includes a preset authorization key.

The confirming of the authorized access may include communicating in a non-contact near field communication scheme.

The confirming of the authorized access may include communicating in a non-contact near field communication scheme using a frequency of 13.56 Hz or a radio frequency identification (RFID) scheme using a frequency of 900 MHz.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram illustrating the configuration of a black box for a vehicle according to an exemplary embodiment of the present invention;

FIG. 2 is a schematic diagram illustrating the configuration of a controller used in a black box for a vehicle according to an exemplary embodiment of the present invention;

FIG. 3 is a schematic diagram illustrating the configuration of an authorizing unit used in a black box for a vehicle according to an exemplary embodiment of the present invention; and

FIG. 4 is a flowchart illustrating the operation of a black box for a vehicle according to an exemplary embodiment of the present invention.

### DETAILED DESCRIPTION OF THE PREFERRED EMBODIMENT

Exemplary embodiments of the present invention will now be described in detail with reference to the accompanying drawings.

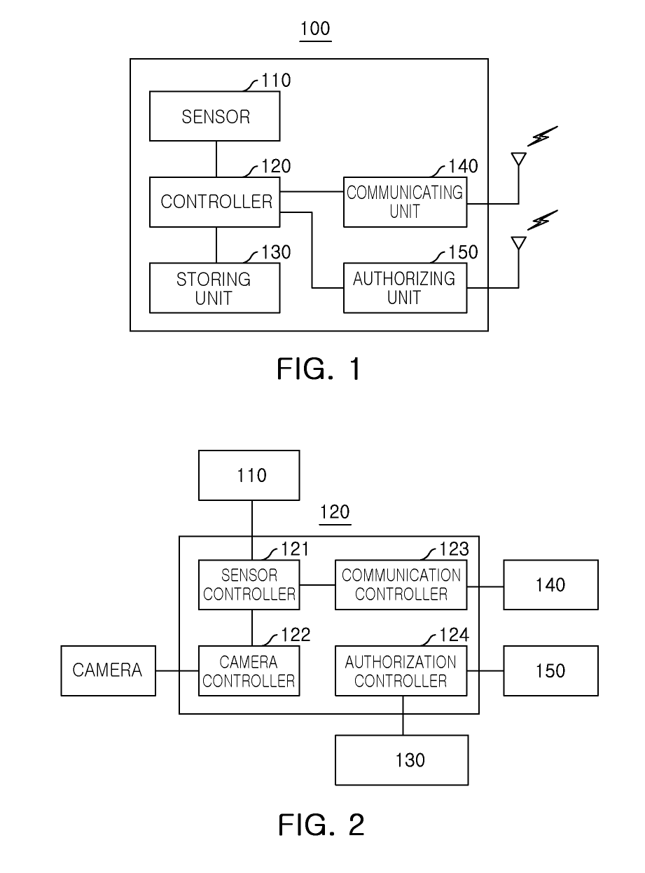

FIG. 1 is a schematic diagram illustrating the configuration of a black box for a vehicle according to an exemplary embodiment of the present invention.

Referring to FIG. 1, a black box 100 for a vehicle according to an exemplary embodiment of the present invention may include a sensor 110, a controller 120, a storing unit 130, a communicating unit 140, and an authorizing unit 150.

The sensor 110 senses the amount of impact applied to a vehicle having the black box 100 mounted therein. In addition, the sensor 110 may acquire data from a navigation apparatus or other external devices that can be mounted in the vehicle to acquire information related to a location of the occurrence of a traffic accident, a vehicle state, or the like.

The controller 120 may determine whether the amount of vehicle impact sensed by the sensor 110 is equal to or greater than a preset reference value. When the sensed amount of impact is equal to or greater than the preset reference value, the controller 120 may recognize that a traffic accident has occurred and perform a control to store video that is being recorded, transmit a rescue signal to a preset object, and acquire stored video data when access to acquire the stored video data is an authorized access.

FIG. 2 is a schematic diagram illustrating the configuration of a controller used in a black box for a vehicle according to an exemplary embodiment of the present invention.

Referring to FIG. 2, the controller 120 may include a sensor controller 121, a camera controller 122, a communication controller 123, and an authorization controller 124.

The sensor controller 121 may determine whether the amount of vehicle impact sensed by the sensor 110 is equal to or greater than the preset reference value, and may recognize that a traffic accident has occurred when the sensed amount of impact is equal to or greater than the present reference value.

The camera controller 122 may control the operation of a camera recording video of a preset region, and may perform a control to store video that is being recorded by the camera when the sensor controller 121 recognizes that the traffic accident has occurred. Herein, the camera controller 122 may perform a control to store video recorded between a first preset time before the vehicle impact is sensed and a second preset time after the vehicle impact is sensed. For example, the camera controller 122 may perform a control to store video from fifteen seconds before the occurrence of the traffic accident to fifteen seconds after the occurrence of the traffic accident in order to record the cause of the traffic accident, a traffic violation item, and the like. The above-mentioned first and second preset times may be set to twenty seconds, respectively, and may also be variously set to the amount of time appropriate for the storage capacity of the storing unit 130.

The communication controller 123 may control the communicating unit 140 to transmit an emergency rescue signal to the preset object when the sensor controller 121 recognizes that the traffic accident has occurred. For example, when the traffic accident has occurred, the communication controller 123 may control the communicating unit 140 to transmit an emergency rescue signal by using a phone number of the preset object such as a hospital, a 119 rescue service, a police station, or the like.

The authorization controller 124 may encrypt the video data stored in the storing unit 130 and may permit the acquisition of the video data stored in the storing unit 130 when it is confirmed that the access to acquire the video data is an authorized access.

Referring to FIG. 1, the storing unit 130 may be a random access memory (RAM), a secure digital (SD) card, or the like, and may store the video that is being recorded through the camera according to the control of the camera controller 122. In order to store the video before the traffic accident has occurred, the video recorded before the traffic accident has occurred may be buffered.

The communicating unit 140 may transmit the emergency rescue signal to the preset object in a preset communication scheme according to the control of the controller 120 at the time of the occurrence of the traffic accident. Here, the communicating unit 140 may transmit the emergency rescue signal in a mobile communication scheme such as a code division multiple access (CDMA) scheme, a global system for mobile communication (GSM) scheme, or the like.

The authorizing unit 150 may confirm whether a user within a preset communication range is a previously authorized user when the user attempts to acquire the video data stored in the storing unit 130.

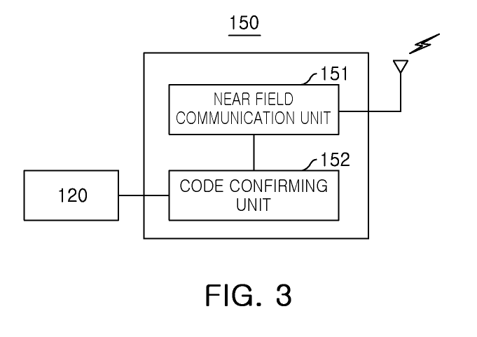

FIG. 3 is a schematic diagram illustrating the configuration of an authorizing unit used in a black box for a vehicle according to an exemplary embodiment of the present invention.

Referring to FIG. 3, the authorizing unit 150 may include a near field communication unit 151 and a code confirming unit 152.

The near field communication unit 151 may communicate with the user within the preset communication range in the preset communication scheme and receive a video data access signal from the user so as to acquire the video data. Here, the communication scheme may be a non-contact near field communication scheme, more specifically, a non-contact near field communication scheme using a frequency of 13.56 Hz or a radio frequency identification (RFID) scheme using a frequency of 900 MHz.

The code confirming unit 152 may confirm whether the video data access signal received in the non-contact near field communication scheme includes a preset authorization key to thereby confirm whether the user attempting to acquire the video data is the authorized user.

Hereinafter, the operation of a black box for a vehicle according to an exemplary embodiment of the present invention will be described in detail with reference to the accompanying drawings.

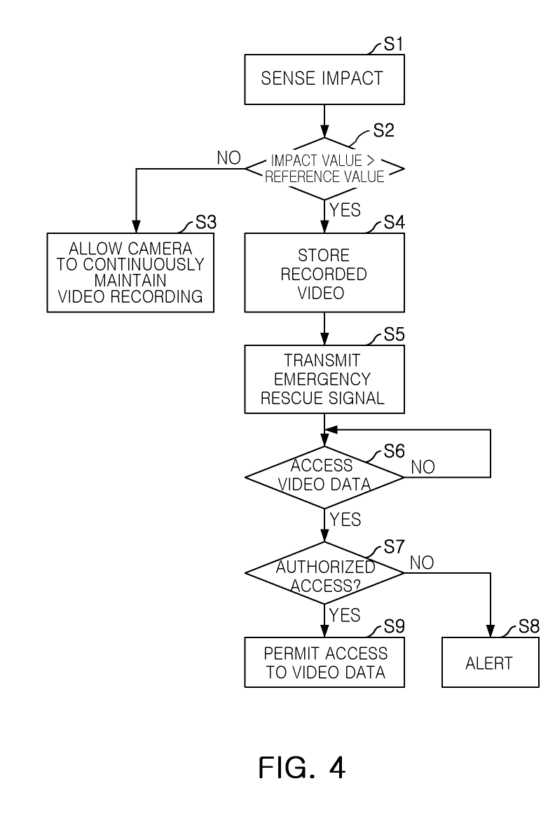

FIG. 4 is a flowchart illustrating the operation of a black box for a vehicle according to an exemplary embodiment of the present invention.

Referring to FIGS. 1 through 4, the camera first records video of a preset region during the operation of the vehicle such as the driving or stopping thereof. At this time, the sensor 110 of the black box 100 for a vehicle according to an exemplary embodiment of the present invention may sense the amount of impact applied to the vehicle (S1), and the sensor controller 121 may compare the sensed amount of impact with a reference value having a preset amount of impact (S2). When the sensed amount of impact is smaller than the reference value, the sensor controller 121 may provide an instruction to maintain the camera operation and the camera controller 122 may perform a control to maintain the existing operation of the camera that is recording the video of the preset region (S3).

Meanwhile, when the sensed amount of impact is greater than the reference value, the sensor controller 121 may give an instruction to store the video that is being recorded by the camera, and the camera controller 122 may perform a control to store the video, recorded from a first preset time before sensing the vehicle impact to a second preset time after sensing the vehicle impact, in the storing unit 130. For example, the camera controller 122 may perform a control to store video from fifteen seconds before the occurrence of the traffic accident to a point in time fifteen seconds after the occurrence of the traffic accident in order to record the cause of the traffic accident, the traffic violation item, and the like (S4).

Then, the sensor controller 121 may instruct the communication controller 123 to transmit an emergency rescue signal, and the communication controller 123 may control the communicating unit 140 to transmit the emergency rescue signal to a hospital, a police station, or the like by using preset phone numbers thereof. Here, the emergency rescue signal may include a vehicle state, a vehicle location, and the like, in addition to the amount of impact sensed by the sensor 110 (S5).

Next, a user of the corresponding vehicle or a staff of the hospital, a police officer, or the like, receiving the emergency rescue signal, may attempt to acquire the video data stored in the storing unit 130 in order to take actions for the traffic accident (S6).

At this time, the authorizing unit 150 may confirm whether the person (user)) attempting to acquire the stored video data is a previously authorized person. The near field communication unit 151 may be connected to the user, capable of communicating in a non-contact near field communication scheme among users within a preset near field communication range, in a peer-to-peer scheme, and the code confirming unit 152 may confirm whether a video data access signal, transmitted by the connected user, includes a preset authorization key (S7) and may generate a preset sound, image, signal, or the like, to alert the user when the user is a non-authorized person (S8).

The authorization controller 124 may perform a control to encrypt the video data stored in the storing unit 130, and may perform a control to decrypt the encrypted video data when an authorized user accesses the stored video data, such that the authorized user may access the stored video data (S9). In addition, the authorization controller 124 may record a user authorization number, a user access date and time, and the like, relating to the user accessing the stored video data to thereby manage a list of access to the stored video data.

Meanwhile, the authorizing unit 150 may perform authorization of a vehicle owner, a preset user, or the like, as well as authorization of the access to the stored video data, to thereby allow for remote control such as door opening, starting of the vehicle, vehicle data transmission, or the like, when the vehicle owner approaches the vehicle.

As set forth above, in a black box for a vehicle according to exemplary embodiments of the present invention, an emergency rescue signal may be automatically transmitted at the time of the occurrence of a traffic accident, and only authorized persons may access video data at the time of the occurrence of the traffic accident, whereby initial rescue action for an injured person may be easily taken and the manipulation and abuse of the video data may be prevented, while the privacy of persons recorded in the video data may be protected.

While the present invention has been shown and described in connection with the exemplary embodiments, it will be apparent to those skilled in the art that modifications and variations can be made without departing from the spirit and scope of the invention as defined by the appended claims.

What is claimed is:

1. A black box for a vehicle, the black box comprising:
a sensor sensing vehicle impact;
a controller performing a control to store video that is being recorded, transmit a rescue signal, permit authorized access to stored video data, when the amount of vehicle impact sensed by the sensor is equal to or greater than a preset reference value;
a storing unit storing the recorded video according to the control of the controller;
a communicating unit transmitting the rescue signal to a preset object according to the control of the controller; and
an authorizing unit authorizing access to the stored video data from the outside.

2. The black box of claim 1, wherein the controller performs a control to store video recorded from a first preset time prior to sensing the vehicle impact to a second preset time after sensing the vehicle impact.

3. The black box of claim 1, wherein the controller includes:
a sensor controller receiving the amount of vehicle impact sensed by the sensor and controlling an operation of the sensor;
a camera controller receiving the sensed amount of vehicle impact from the sensor controller and controlling an operation of a camera recording video;
a communication controller controlling communication with the preset object according to the sensed amount of vehicle impact from the sensor controller; and
an authorization controller encrypting the video data stored in the storing unit and permitting access to the encrypted video data when the access is authorized by the authorizing unit.

4. The black box of claim 3, wherein the authorizing unit includes:
a near field communication unit receiving a video data access signal from a user within a preset near field communication range; and
a code confirming unit confirming whether the video data access signal transmitted through the near field communication unit includes a preset authorization key.

5. The black box of claim 4, wherein the near field communication unit communicates in a non-contact near field communication scheme.

6. The black box of claim 5, wherein the near field communication unit communicates in a non-contact near field communication scheme using a frequency of 13.56 Hz or a radio frequency identification (RFID) scheme using a frequency of 900 MHz.

7. An access authorization method of a black box for a vehicle, the access authorization method comprising:
sensing an amount of vehicle impact;
storing video that is being recorded and transmitting a rescue signal to a preset object when the sensed amount of vehicle impact is equal to or greater than a preset reference value; and
confirming whether access to stored video data is an authorized access.

8. The access authorization method of claim 7, wherein the storing of the video that is being recorded includes storing video recorded from a first preset time prior to sensing the vehicle impact to a second preset time after sensing the vehicle impact.

9. The access authorization method of claim 7, wherein the confirming of the authorized access includes encrypting the stored video data and permitting access to the encrypted video data when the access is authorized.

10. The access authorization method of claim 9, wherein the confirming of the authorized access includes receiving a video data access signal from a user within a preset near field communication range, and confirming whether the video data access signal includes a preset authorization key.

11. The access authorization method of claim 10, wherein the confirming of the authorized access includes communicating in a non-contact near field communication scheme.

12. The access authorization method of claim 11, wherein the confirming of the authorized access includes communicating in a non-contact near field communication scheme using a frequency of 13.56 Hz or a radio frequency identification (RFID) scheme using a frequency of 900 MHz.
